(19) United States
(12) Patent Application Publication
(10) Pub. No.: US 2003/0074668 A1
(43) Pub. Date: Apr. 17, 2003

(54) Quality of service and transponder utilization billing system

(76) Inventors: James W. Carlin, Holmdel, NJ (US); Jurgen Dannwolf, Bricktown, NJ (US); Robert E. Schroeder, Branchburg, NJ (US); Robert Seiwell, Coopersburg, NJ (US)

Correspondence Address: Joyce Kosinski, Loral Space and Communications, Ltd., Suite 303, 655 Deep Valley Drive, Rolling Hills Estates, CA, 90274, US

(21) Appl. No.: 09/978,808

(22) Filed: Oct. 17, 2001

(51) Int. Cl. H04N 7/16

(52) U.S. Cl. 725/95

(57) ABSTRACT

A system and method for providing quality of service and transponder utilization billing for use with a data broadcasting system. The data broadcast system includes a plurality of receivers coupled to a plurality of channel encoders, a multiplexer for multiplexing encoded channels, and a transmitter for transmitting the channels. A video system controller is coupled to the multiplexer and channel encoders. A content access management system schedules, tracks, and reports customer content, and a transponder management system outputs billing reports. In accordance with the present invention, the multiplexer generates statistical feedback to the encoders to control encoding quantization rates to achieve optimum channelized video throughput. The video system controller generates quality parametrics comprising average channel quantization rates that are indicative of the quality of each channel of the data broadcasting system. A quality of service and transponder utilization billing system generates schedule and utilization data for each channel of the data broadcasting system, matches average channel quantization rates are to preassigned class bins that represent pre-agreed quality of service levels for respective customers, periodically aligns the class bins to a customer's product schedule, and generates product and class utilization summary. The transponder management system processes the product and class utilization summary to track transponder usage and match each customer to a rate identifier table to periodically render an integrated customer bill reflecting quality of service delivered with content over time.

### BACKGROUND

The present invention relates generally to satellite communication systems and methods, and more particularly, to quality of service, transponder utilization and billing systems and methods.

The assignee of the present invention operates communication satellites that provide communication services using a global telecommunications network. Traditional analog transponder uplink service involves straightforward billing determination for time-bandwidth usage without consideration of content. Over the years the assignee of the present invention has developed many powerful scheduling and billing tools such as a Transponder Management System (TMS) to address these needs. Recent additions to services offered by the assignee of the present invention include offering fractional transponder bandwidth with time slice availability to satisfy part time and occasional users. Interactive sales tools have been designed to support channelized services by determining power-bandwidth-time relationships using off-line calculations to quote service performance and support billing. However, inclusion of statistical multiplexing in a digital video service to gain spectral efficiency adds another dimension for service calculation that is based on time variant channel characteristics that are aggregated across the serving transponder.

Future digital video service(s) provided by the assignee of the present invention will use industry standard MIPEG-2 encoding technology with statistical multiplexing to enhance channel capacity and service revenue as compared to a Constant Bit Rate (CBR) channelized approach. This established art uses statistical control technology to dynamically balance the aggregate transponder resource across the available channel set by increasing or decreasing channel quantization rates to accommodate real-time motion changes between channels. Vendor supplied technology optimizes video throughput at the expense of encoded quality on a frame-by-frame basis by using elaborate feed forward algorithms and chip sets that negotiate encoder quantization rates in concert with the multiplexer assigned to a transponder. This dynamic resource balancing across the channel set is usually constrained within preset minimum and maximum levels established for each channel at service provisioning.

During operation, it is possible that video buffer overflows and other events can occur during unanticipated motion extremes or with uncorrelated motion peaks across the channel set. These events can cause temporal artifacts and degrade overall viewing quality. If impairments become severe then operators may re-adjust static quantization limits to provide compensation. In addition, content from one programmer may unintentionally dominate transponder resources shared with other programmers. Quality of service is generally improved when the statistical controls increase the quantization rate used to encode the video stream.

It is therefore an objective of the present invention to provide for improved quality of service, transponder utilization and billing systems and methods.

### SUMMARY OF THE INVENTION

To accomplish the above and other objectives, the present invention provides for a system and method that couples a digital video service having a statistical encoding multiplexing system with a transmission billing system to accurately represent a customer's value proposition. The quality of service and transponder utilization billing system and method autonomously links implied digital video quality on a per channel basis with a billing system that closely tracks customer utilization and then periodically bills for service quality and resources delivered over time.

The quality of service and transponder utilization billing system provides a computational interface that accepts input from the video system controller and content access management system and computes or generates a utilization summary. The average channel quantization rates, reported by the video controller, are matched to preassigned class bins that represent pre-agreed quality of service levels. The class bins are periodically aligned to a programmer's (customer's) product schedule to support customer billing intervals. The product and class utilization summary is periodically reported to support the customer's billing cycle. A transponder management system (TMS) or equivalent accepts the channelized utilization summary, tracks transponder usage and then matches each customer to a TMS rate identifier table to periodically render an integrated customer bill reflecting quality of service delivered with content over time.

An exemplary quality of service and transponder utilization billing method used in a data broadcasting system comprises the following steps. Statistical feedback is generated to control encoding quantization rates to achieve optimum channelized video throughput. Quality parametrics comprising average channel quantization rates are generated that are indicative of the quality of each channel of the data broadcasting system. Schedule and utilization data are generated for each channel of the data broadcasting system.

The average channel quantization rates are matched to preassigned class bins that represent pre-agreed quality of service levels. The class bins are periodically aligned to a customer's product schedule. A product and class utilization summary is generated. The product and class utilization summary is processed to track transponder usage and match each customer to a rate identifier table to periodically render an integrated customer bill reflecting quality of service delivered with content over time.

The present invention provides a value proposition that transponder expense be properly represented across a channel set supporting several programmers with varying content. Real-time programming statistics are generally unknown until live content streams are encoded together. The present invention may be used to provide programmers (customers) with a form of statistical quality protection. Some examples of this service capability are, billing for quality delivered above average static settings, billing for sustained quality improvements at maximum static settings, and premium billing for overload quality improvements above static settings using reserved resources.

### BRIEF DESCRIPTION OF THE DRAWINGS

The various features and advantages of the present invention may be more readily understood with reference to the following detailed description taken in conjunction with the accompanying drawings, wherein like reference numerals designate like structural elements, and in which:

FIG. 1 illustrates one possible embodiment of an exemplary quality of service and transponder utilization billing system in accordance with the principles of the present invention; and

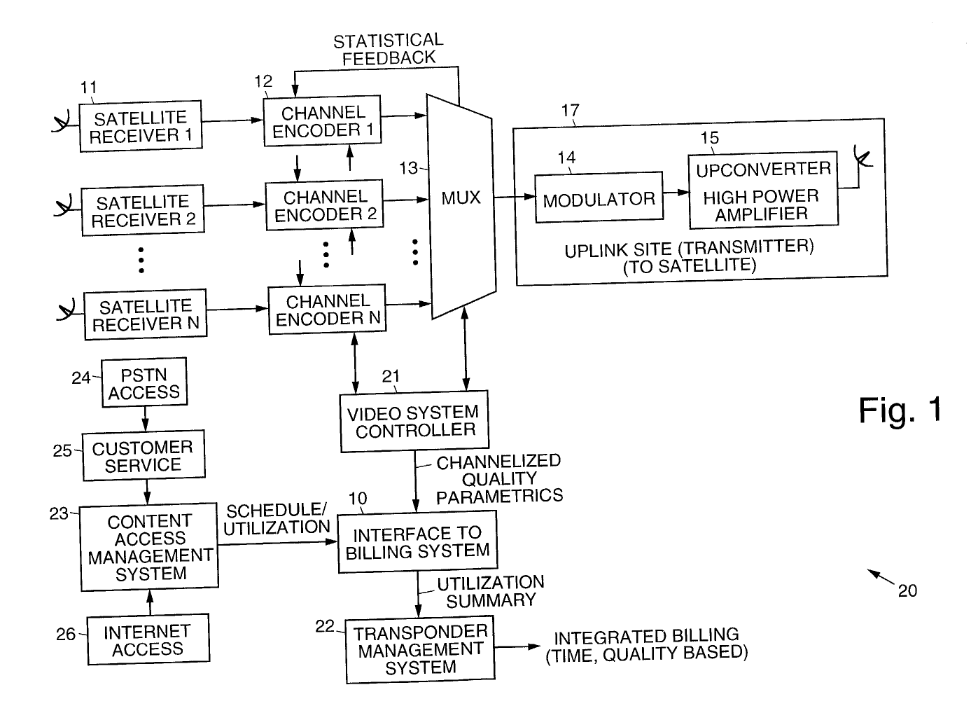

FIG. 2 is a flow diagram that illustrates an exemplary quality of service and transponder utilization billing method in accordance with the principles of the present invention.

### DETAILED DESCRIPTION

Referring to the drawing figure, it illustrates one possible embodiment of an exemplary quality of service and transponder utilization billing system 10 in accordance with the principles of the present invention. The exemplary quality of service and transponder utilization billing system 10 is used with a satellite-based data broadcasting system 20.

The data broadcasting system 20 comprises a plurality of satellite receivers 11 (receivers 1 to N) whose respective outputs are coupled to a plurality of MPEG-2 channel encoders 12 (encoders 1 to N). A multiplexer (MUX) 13 is coupled to outputs of each of the plurality of MPEG-2 channel encoders 12. In accordance with the present invention, the multiplexer 13 outputs statistics including quality parametrics comprising average channel quantization rates that are indicative of the quality of each channel of the data broadcasting system 20 that are fed back to the plurality of channel encoders 12.

The multiplexer 13 is coupled to an uplink site 17 or transmitter 17 that uplinks data to one or more satellites (not shown), for example. The uplink site 17 (transmitter 17) includes a modulator 14 that receives the multiplexed output of the multiplexer 13. and an upconverter and high power amplifier 15 that upconverts and amplifies the output of the modulator 14. The upconverted and amplified signal is coupled by to an antenna that uplinks the signal to the satellite.

A video system controller 21 is coupled to the plurality of MPEG-2 channel encoders 12 and to the multiplexer 13. The video system controller 21 is used to manage minimum and maximum channel encoding rates of the channel encoders 12. In accordance with the present invention, the video system controller 18 reports and outputs individual channel statistics in response to content carried by the respective channels.

The satellite receivers 11 receive programming that is applied to the MPEG-2 channel encoders 12. Real-time statistical feedback from the multiplexer 13 is used to control quantization rate of encoders 12 to achieve an optimum channelized video throughput to the uplink site 17.

A content access management system 23 and is used to schedule, track, and report customer content. Scheduling and access to the content access management system 23 is provided to customers by way of the Internet 26 or by using telephone access 24 to customer service personnel 25. The content access management system 19 reports and outputs schedule and utilization information.

The quality of service and transponder utilization billing system 10 provides a computational interface that receives input from the video system controller 21 and from the content access management system 23. The quality of service and transponder utilization billing system 10 is coupled to a transponder management system (TMS) 22. In accordance with the present invention, the quality of service and transponder utilization billing system 10 computes a utilization summary for use by the transponder management system 22.

In the quality of service and transponder utilization billing system 10, the average channel quantization rates, reported by the video system controller 21, are first matched to preassigned class bins that represent pre-agreed quality of service levels. These class bins are then periodically sampled and then matched to the closest programmer's product schedule as often as every 15 minutes to support the minimum billing interval.

The resultant product and class utilization summary is periodically reported to the transponder management system 22 to support monthly programmer billing cycles, for example. The transponder management system 22 receives the channelized utilization summary, tracks transponder usage and then matches each customer to a TMS rate identifier table to periodically render an integrated customer bill reflecting quality of service delivered with content over time.

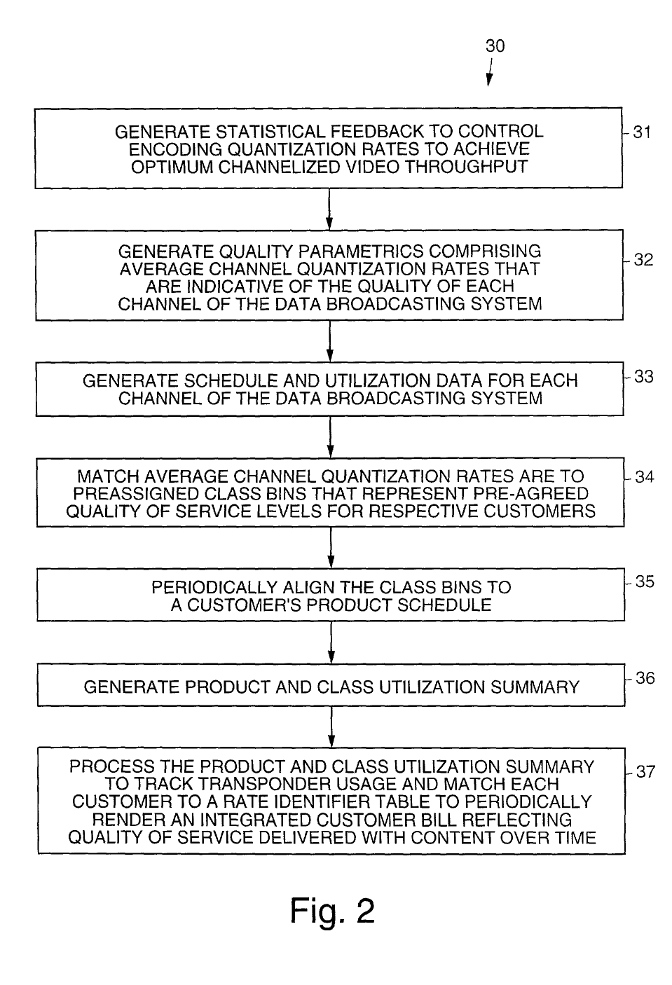

Referring to FIG. 2 is a flow diagram that illustrates an exemplary quality of service and transponder utilization billing method 30 in accordance with the principles of the present invention for use with a data broadcasting system. The exemplary quality of service and transponder utilization billing method 30 comprises the following steps.

Statistical feedback is generated 31 to control encoding quantization rates to achieve optimum channelized video throughput. Quality parametrics comprising average channel quantization rates are generated 32 that are indicative of the quality of each channel of the data broadcasting system. Schedule and utilization data are generated 33 for each channel of the data broadcasting system.

The average channel quantization rates are matched 34 to preassigned class bins that represent pre-agreed quality of service levels. The class bins are periodically aligned 35 to a customer's product schedule. A product and class utilization summary is generated 36. The product and class utilization summary is processed 37 to track transponder usage and match each customer to a rate identifier table to periodically render an integrated customer bill reflecting quality of service delivered with content over time.

Thus, a quality of service and transponder utilization billing system has been disclosed. It is to be understood that the above-described embodiment is merely illustrative of some of the many specific embodiments that represent applications of the principles of the present invention. Clearly, numerous and other arrangements can be readily devised by those skilled in the art without departing from the scope of the invention.

What is claimed is:

1. Apparatus for use with a data broadcast system that includes a plurality of receivers, a plurality of channel encoders coupled to the plurality of receivers, a multiplexer coupled to the channel encoders, a transmitter coupled to the multiplexer, a video system controller coupled to the multiplexer and channel encoders, a content access management system that schedules, tracks, and reports customer content, and a transponder management system, wherein the improvement is comprises:
a multiplexer that generates statistical feedback to the encoders to control encoding quantization rates to achieve optimum channelized video throughput;
a video system controller that generates quality parametrics comprising average channel quantization rates that are indicative of the quality of each channel of the data broadcasting system;
a quality of service and transponder utilization billing system that generates schedule and utilization data for each channel of the data broadcasting system, matches average channel quantization rates to preassigned class bins that represent pre-agreed quality of service levels for respective customers, periodically aligns the class bins to a customer's product schedule, and generates product and class utilization summary; and
a transponder management system that processes the product and class utilization summary to track transponder usage and match each customer to a rate identifier table to periodically render an integrated customer bill reflecting quality of service delivered with content over time.

2. The system recited in claim 1 wherein the video system controller manages minimum and maximum channel encoding rates of the channel encoders, and reports individual channel statistics in response to content carried by the channels.

3. A method for providing quality of service and transponder utilization billing in a data broadcasting system, comprising the steps of:
generating statistical feedback to control encoding quantization rates to achieve optimum channelized video throughput;
generating quality parametrics comprising average channel quantization rates that are indicative of the quality of each channel of the data broadcasting system;
generating schedule and utilization data for each channel of the data broadcasting system;
matching average channel quantization rates are to preassigned class bins that represent pre-agreed quality of service levels for respective customers;
periodically aligning the class bins to a customer's product schedule;
generating product and class utilization summary; and
processing the product and class utilization summary to track transponder usage and match each customer to a rate identifier table to periodically render an integrated customer bill reflecting quality of service delivered with content over time.

4. The method recited in claim 3 wherein the step of generating quality parametrics comprises the steps of:
managing minimum and maximum channel encoding rates of channel encoders; and
reporting individual channel statistics in response to content carried by the channels.
